(19) United States
(12) Patent Application Publication
(10) Pub. No.: US 2008/0197124 A1
(43) Pub. Date: Aug. 21, 2008

(54) Heater Jacket For Heat Convection

(75) Inventor: Kyung-Soon Shin, Gyeonggi-do (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: AON INSTRUMENT CO., LTD., Gyeonggi-do (KR)

(21) Appl. No.: 11/912,745

(22) PCT Filed: Apr. 25, 2006
(86) PCT No.: PCT/KR06/01555

§ 371 Date: Oct. 26, 2007

(30) Foreign Application Priority Data
Apr. 26, 2005 (KR) 10-2005-0034482

(51) Int. Cl. H05B 3/10; H05B 3/54; H05B 3/58; H05B 3/02

(52) U.S. Cl. 219/535; 219/539

(57) ABSTRACT

The present invention generally relates to an insulating heater jacket, and more particularly, to a silicone rubber and a heater controller for an insulating heater jacket. According to the present invention, the use of the silicone rubber molded out of a mixture of polymethyl vinyl silica oxide solutions improves durability. Furthermore, a duplex heating pad is provided using first and second heaters, and a microprocessor and a temperature sensor monitor malfunction of the dual heating wires and perform control in such a manner that upon malfunction of one of the heating wires, the other heating wire can be operated. Therefore, there are advantages in that temperature can be accurately controlled and reliable performance can be always ensured without any malfunction.

### TECHNICAL FIELD

The present invention generally relates to an insulating heater jacket, i.e. a heater jacket for heat convection, and more particularly, to a heater jacket for heat convection comprising a novel silicone rubber jacket, a heating wire structure and a heater controller for the heater jacket.

### BACKGROUND ART

In processes of manufacturing semiconductors, liquid crystals, or other chemical products, a variation in the temperature of liquid or gas transported while passing through a pipe, a tube, a valve body or the like may cause a problem in that the fluid is solidified in the form of powder which in turn clogs up the tube.

For example, in a semiconductor fabrication process such as a low pressure chemical vapor deposition (LPCVD) process or a plasma etching process, a reaction by-product such as ammonium chloride (NH₄Cl) gas or aluminum chloride (AlCl₃) gas may be included in gas emitted from a reaction chamber. If a pipe for use in transporting such a by-product is maintained at room temperature, the ammonium chloride gas tends to be solidified and deposited on an inner wall of the pipe.

Consequently, the solid powder deposited on the inner wall of the pipe clogs up the pipe or tube and blocks a normal flow passage to cause decrease in conductance. Thus, pressure required for the process may not be maintained. To solve the aforementioned problems, a transportation pipe is surrounded by a heater matt or heater jacket in the related industry to keep constant temperature in the pipe and to prevent the solidification and deposition of gas to be transported. Hereinafter, the word of ‘insulating heater jacket’ means the heater jacket for heat convection of the present invention.

The technique of such an insulating heater jacket or heater matt for a transportation pipe is disclosed in Korean Patent Laid-Open Publication No. 10-2002-0085024. Although the invention disclosed in the aforementioned document solves a problem of damage to a mechanical contact temperature control circuit, there are problems in that a silicone rubber constituting the insulating heater jacket is easily damaged and the entire heater jacket should be exchanged upon malfunction of a heating wire thereof.

### DISCLOSURE OF INVENTION

### Technical Problem

Accordingly, a primary object of the present invention is to provide a reliable insulating heater jacket, wherein even though a specific heating wire of the heater jacket malfunctions, heat can be supplied to a pipe using a redundant heating wire.

In addition to the primary object of the present invention, a secondary object of the present invention is to provide an insulating heater jacket equipped with a high-quality silicone rubber resistant to an ambient environment.

In addition to the primary object of the present invention, a tertiary object of the present invention is to provide a control device that always ensures a reliable operation of the insulating heater jacket by monitoring and detecting malfunction of a heating wire.

### Technical Solution

To achieve the above objects, the present invention provides an insulating heater jacket for surrounding a surface of a pipe with gas or liquid flowing therein to maintain the temperature of the pipe at a predetermined temperature. The insulating heater jacket comprises a heating pad having heating wires that supply heat to the pipe and are arranged in a plurality of parallel connection configurations and wrapped by a silicone fiber glass sheath; one or more temperature sensors mounted on the heating wires of the heating pad to detect the temperature of the heating pad; a silicone rubber molded by a mold using a mixture of polymethyl vinyl silica oxide solutions so that the silicone rubber can wrap the heating pad; and a controller for performing control by receiving the value of temperature detected by the temperature sensor, determining whether a specific heating wire of the heating wires arranged in the plurality of parallel connection configurations malfunctions, and turning on an alternative heating wire connected in parallel if the specific heating wire malfunctions.

### BRIEF DESCRIPTION OF DRAWINGS

FIG. 1 is a diagram showing the overall configuration of an insulating heater jacket according to the present invention;

FIG. 2 is a diagram schematically showing the configuration of heating wires employed in the insulating heater jacket according to the present invention;

FIG. 3 is a schematic diagram showing the sectional structure of the heating wires employed in the insulating heater jacket according to the present invention;

FIG. 4 is a diagram showing the configuration of a heater controller for controlling a duplex heating wire structure according to the present invention; and

FIG. 5 is a flowchart illustrating a method of controlling the operation of the dual heating wires according to a preferred embodiment of the present invention.

### BEST MODE FOR CARRYING OUT THE INVENTION

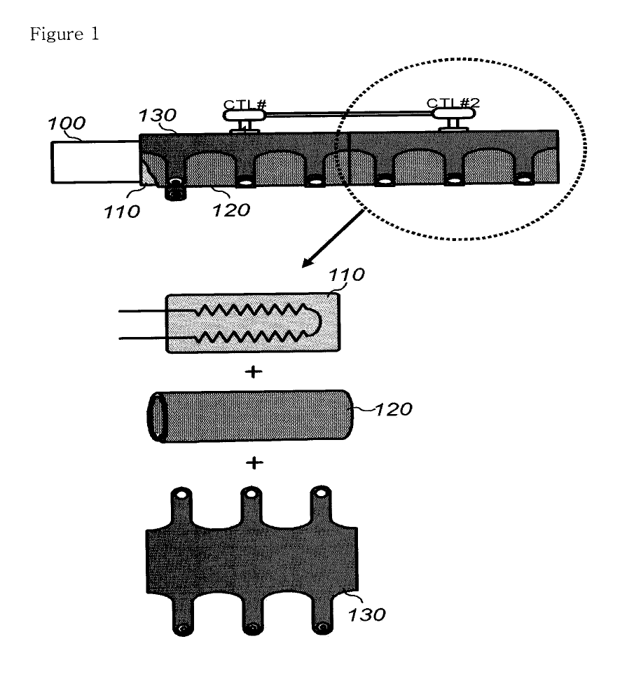

Hereinafter, an insulating heater jacket of the present invention will be described with reference to FIGS. 1 to 5 of the accompanying drawings.

FIG. 1 is a diagram showing the overall configuration of an insulating heater jacket according to the present invention. FIG. 1 shows a heating pad 110 for radially surrounding a pipe 100 through which liquid or gas is transported. Heating wires such as nichrome wires are wound around the heating pad 110.

A silicone rubber 120 as an insulating material wraps the heating pad 110 that surrounds the pipe 100. Finally, a sheath 130 equipped with buttons surrounds the silicone rubber. The silicone rubber 120 of the insulating heater jacket according to the present invention is made of an adhesive silica mixture comprising 75˜85% of dimethyl vinyl silica oxide or trimethyl vinyl silica oxide and 10˜15% of aerosil.

In a preferred embodiment of the present invention, the silicone rubber can be manufactured by mixing DSF 400A and DSF 400B available from Dong-Yang Silicone Co., Ltd. as follows.

First, a mold is placed in an oven under an atmosphere at about 40° C. to 100° C. for more than 15 to 30 minutes, and the aforementioned DSF 400A and DSF 400B solutions are sufficiently mixed together at a weight/volume ratio of 1:1. Then, the mixed solution is filled into the mold that in turn is placed again in the oven under the atmosphere at 40° C. to 100° C. for more than 15 to 30 minutes to complete the molding of the silicone rubber. The silicone rubber could be manufactured through extrusion moulding process as well as injection moulding process. Considering the aspect of productivity and production cost, the extrusion moulding is preferable to the injection moulding although the extrusion moulding requires further processing, for example cutting and punching for wiring.

Since the silicone rubber manufactured according to the present invention is tough and has higher durability and heat resistance, it is possible to minimize damage thereto caused by an ambient environment as compared with a conventional silicone rubber.

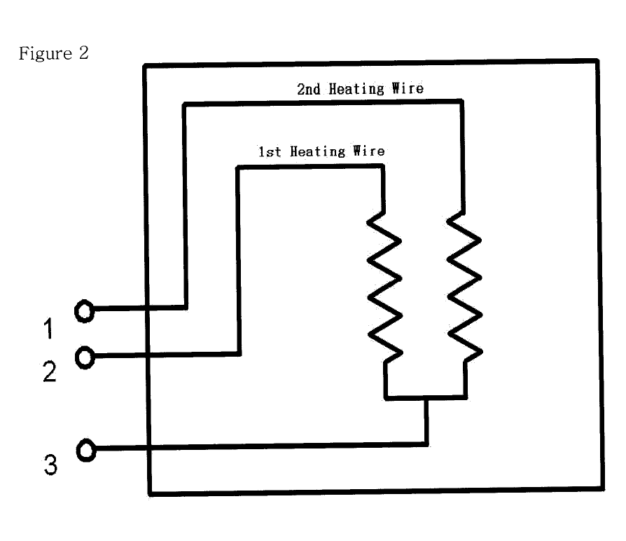

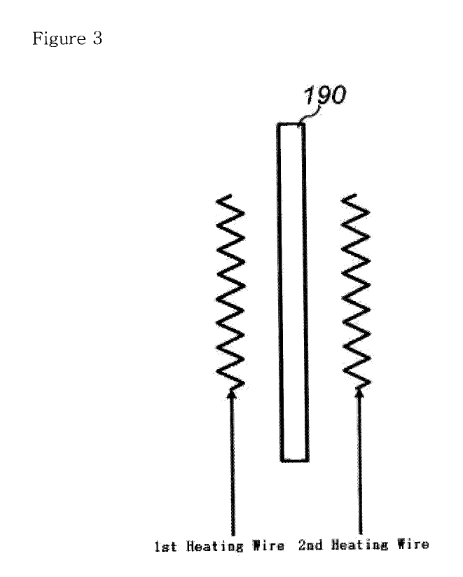

FIGS. 2 and 3 are diagrams schematically showing the configuration of the heating wires employed in the insulating heater jacket according to the present invention and the sectional structure of the heating wires employed in the insulating heater jacket according to the present invention, respectively.

In a first embodiment of the insulating heater jacket of the present invention, the insulating heater jacket comprises a duplex heating wire structure including the first and the second heating wires arranged in parallel as shown in FIG. 2, so that upon malfunction of one of the heating wires due to aging or defection thereof, the other heating wire can be operated.

Referring to FIG. 2, a surface load density is calculated (e.g., the required resistance value of a nichrome wire is calculated when a quantity of heat of 190 W is needed), and the two heating wires are arranged in a duplex configuration. If the second heating wire between terminals 1 and 3 is defective and malfunctions, the first heating wire between terminals 2 and 3 is operated, thereby extending the lifetime of the insulating heater jacket. At this time, in the preferred embodiment of the present invention, temperature sensors, i.e., thermistors, can be located on the first and second heating wires or at positions where the surface load densities are identical with to each other.

FIG. 3 shows a second embodiment of the present invention, wherein a duplex heating wire structure is configured by inserting first and second heating wires in parallel with a silicone fiber glass sheath 190 interposed therebetween. That is, the first embodiment of the present invention is characterized by the parallel connection of the heating wires in a single-layered heating pad, whereas the second embodiment of the present invention is characterized by the insertion of the dual heating wires into the a two-layered heating pad.

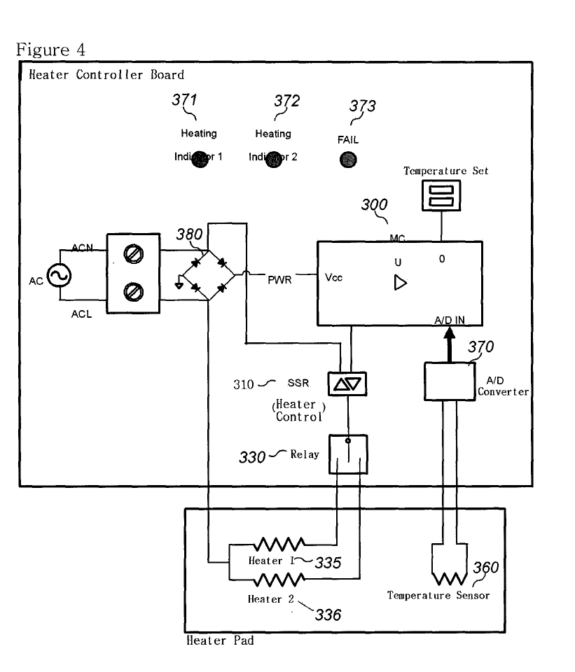

FIG. 4 is a diagram showing the configuration of a heater controller for controlling the duplex heating wire structure according to the present invention. Referring to FIG. 4, the heater controller comprises a microprocessor 300 for controlling a heater, and an electronic contact relay (SSR) 310 for controlling the heater. AC 110V/220V is input into a transformer so that AC 6V can be output. The AC 6V is applied to contacts of a bridge diode 380 to output DC 6V that in turn is applied to the SSR 310.

When a desired temperature to be controlled is set, the value of current temperature is read by a temperature sensor 360 and then subjected to A/D conversion by an A/D converter 370. If the detected current temperature is below the set temperature, the SSR 310 remains in an ON state to perform heating. When the current temperature reaches the set temperature, the SSR 310 is turned off. In such a way, the temperature of the heater is controlled. At this time, the relay 330, which is preferably a FORM-C type, causes heater 1 335 (corresponding to the ‘first heating wire’) to perform heating, and causes heater 2 336 (corresponding to the ‘second heating wire’) to perform heating when a heating wire of heater 1 malfunctions and the temperature sensor 360 detects the malfunction of heater 1.

As a preferred embodiment of the present invention, a method of determining malfunction of a heater can be performed as follows. While heater 1 performs heating, LEDs of a heater indicator 1 371 are turned on or off to indicate a current control state of the temperature of the heater 1. Likewise, while heater 2 performs heating, LEDs of heater indicator 2 372 are turned on or off to indicate a current control state of the temperature of the heater 2.

Meanwhile, when the temperature of heater 1 is lowered below 80% of the set temperature, heater 1 is treated as being in a FAIL state and heater 2 is then operated.

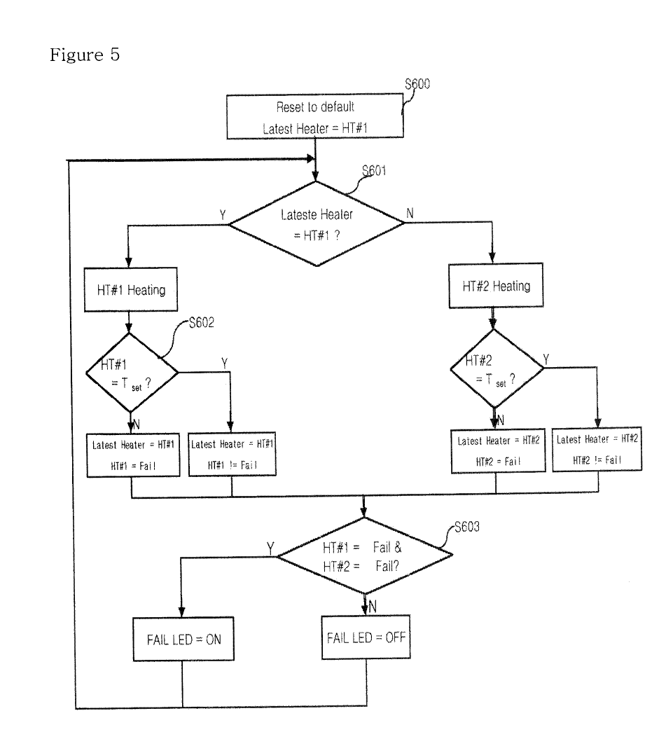

FIG. 5 is a flowchart illustrating a method of controlling the operation of the dual heating wires according to a preferred embodiment of the present invention. Referring to FIG. 5, parameters of the microprocessor for controlling the heating wires are initialized (step S600), and one of the heating wires is selected (step 601). Then, it is determined whether current temperature reaches a set temperature within a predetermined period of time using a specific heater (step S602). If not, ‘FAIL’ is determined and a process of operating an alternative redundant heating wire is performed (step S603).

As described above, the present invention provides a silicon rubber molded out of a mixture of polymethyl vinyl silica oxide solutions, and an insulating heater jacket employing a duplex heating wire structure, so that temperature can be accurately controlled and reliable performance can be ensured without malfunction.

According to the present invention, the use of the silicone rubber molded out of a mixture of polymethyl vinyl silica oxide solutions improves durability. Furthermore, a duplex heating pad is provided using first and second heaters, and a microprocessor and a temperature sensor monitor malfunction of the dual heating wires and perform control in such a manner that upon malfunction of one of the heating wires, the other heating wire can be operated. Therefore, there are advantages in that temperature can be accurately controlled and reliable performance can be always ensured without any malfunction.

In the foregoing, the technical features and advantages of the present invention have been broadly described for better understanding of the appended claims. Those skilled in the art can use the inventive concept and embodiments of the present invention disclosed above as fundamentals of other designs or modifications for achieving objects similar to those of the present invention. In addition, it will be apparent that various changes, substitutions and modifications can be made to such equivalent structures changed or modified by those skilled in the art without departing from the spirit and scope of the present invention defined by the claims.

What is claimed is:

1. An insulating heater jacket for surrounding a surface of a pipe with gas or liquid flowing therein to maintain the temperature of the pipe at a predetermined temperature, comprising:
a heating pad having heating wires for supplying heat to the pipe, the heating wires being arranged in a plurality of parallel connection configurations and wrapped by a silicone fiber glass sheath;
one or more temperature sensors mounted on the heating wires of the heating pad to detect the temperature of the heating pad;
a silicone rubber molded by a mold using a mixture of polymethyl vinyl silica oxide solutions so that the silicone rubber can wrap the heating pad; and
a controller for performing control by receiving the value of temperature detected by the temperature sensor, determining whether a specific heating wire of the heating wires arranged in the plurality of parallel connection configurations malfunctions, and turning on an alternative heating wire connected in parallel if the specific heating wire malfunctions.

2. An insulating heater jacket for surrounding a surface of a pipe with gas or liquid flowing therein to maintain the temperature of the pipe at a predetermined temperature, comprising:
a heating pad having heating wires for supplying heat to the pipe, the heating wires being arranged in a plurality of parallel connection configurations and wrapped by a silicone fiber glass sheath;
one or more temperature sensors mounted on the heating wires of the heating pad to detect the temperature of the heating pad;
a silicone rubber wrapping the heater pad, having a cylindrical shape with a hollow formed longitudinally and through the outer surface and the hollow, and manufactured by extrusion moulding process using a mixture of polymethyl vinyl silica oxide solutions so that the silicone rubber can wrap the heating pad; and
a controller for performing control by receiving the value of temperature detected by the temperature sensor, determining whether a specific heating wire of the heating wires arranged in the plurality of parallel connection configurations malfunctions, and turning on an alternative heating wire connected in parallel if the specific heating wire malfunctions.
